(19) United States
(12) Patent Application Publication
(10) Pub. No.: US 2008/0059642 A1
(43) Pub. Date: Mar. 6, 2008

(54) SYSTEM AND METHOD FOR DISPLAYING IN-NETWORK INDICATORS

(75) Inventors: Kulvir S. Bhogal, Fort Worth, TX (US); Rick A. Hamilton, Charlottesville, VA (US); Nizamudeen Ishmael, Austin, TX (US); Alexandre Polozoff, Bloomington, IL (US); Mandeep S. Sidhu, Pflugerville, TX (US)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/464,954

(22) Filed: Aug. 16, 2006

(51) Int. Cl. G06F 15/16

(52) U.S. Cl. 709/229; 379/201.01

(57) ABSTRACT

A method for notifying one or more users of an in-network call, the method comprising: providing each of the one or more users with one or more transmitting/receiving devices, each of the one or more transmitting/receiving devices having a display screen; allowing a first user of the one or more users to call a second user of the one or more users; determining a service provider of the first user; determining a service provider of the second user; determining whether the service provider of the first user matches the service provider of the second user; and automatically notifying the first user and the second user of the in-network call when it is determined that the service provider of the first user matches the service provider of the second user.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to “in-network” indicators, and particularly to a method for allowing cellular telephone users to ascertain whether their call is “in-network,” and thus potentially subject to certain cost-saving offers offered by service providers.

2. Description of Background

People nowadays rely heavily on cell phones as a form of communication. However, cell phone minutes can be costly and therefore users are often wary of talking too long on their cell phones. However, today many service providers offer free calling to others being in the same network. Often, most users fail to take advantage of this valuable and cost-saving option because there is no indication which allows users to ascertain whether or not the caller or recipient uses the same provider without asking directly, which is something most users fail to do or even think about asking. Therefore, there is no way of automatically notifying users that they are in the same phone network.

Considering the limitations of the aforementioned methods, it is clear that there is a need for a method for allowing cellular telephone users to determine whether their calls are “in-network” and thus potentially subject to certain cost-saving offers offered by service providers. Therefore, a notification means for automatically notifying users of “in-network” is highly desirable.

### SUMMARY OF THE INVENTION

The shortcomings of the prior art are overcome and additional advantages are provided through the provision of a method for notifying one or more users of an “in-network” call, the method comprising: providing each of the one or more users with one or more transmitting/receiving devices, each of the one or more transmitting/receiving devices having a display screen; allowing a first user of the one or more users to call a second user of the one or more users; determining a service provider of the first user; determining a service provider of the second user; determining whether the service provider of the first user matches the service provider of the second user; and automatically notifying the first user and the second user of the “in-network” call when it is determined that the service provider of the first user matches the service provider of the second user.

The shortcomings of the prior art are overcome and additional advantages are provided through the provision of a system for notifying one or more users of an “in-network” call, the system comprising: a network; and a host system in communication with the network, the host system including software to implement a method comprising: providing each of the one or more users with one or more transmitting/receiving devices, each of the one or more transmitting/receiving devices having a display screen; allowing a first user of the one or more users to call a second user of the one or more users; determining a service provider of the first user; determining a service provider of the second user; determining whether the service provider of the first user matches the service provider of the second user; and automatically notifying the first user and the second user of the “in-network” call when it is determined that the service provider of the first user matches the service provider of the second user.

The shortcomings of the prior art are overcome and additional advantages are provided through the provision of a computer program product for notifying one or more users of an “in-network” call, the computer program product comprising: providing each of the one or more users with one or more transmitting/receiving devices, each of the one or more transmitting/receiving devices having a display screen; allowing a first user of the one or more users to call a second user of the one or more users; determining a service provider of the first user; determining a service provider of the second user; determining whether the service provider of the first user matches the service provider of the second user; and automatically notifying the first user and the second user of the “in-network” call when it is determined that the service provider of the first user matches the service provider of the second user.

Additional features and advantages are realized through the techniques of the present invention. Other embodiments and aspects of the invention are described in detail herein and are considered a part of the claimed invention. For a better understanding of the invention with advantages and features, refer to the description and the drawings.

### TECHNICAL EFFECTS

As a result of the summarized invention, technically we have achieved a solution that provides for a method for allowing cellular telephone users to know whether their calls are “in-network,” and thus potentially subject to certain cost-saving offers offered by service providers.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a flowchart describing a telephone communication between two users according to the exemplary embodiments of the present invention; and

FIG. 2 illustrates one example of a flowchart describing a method for determining whether a call is “in-network” according to the exemplary embodiments of the present invention.

### DETAILED DESCRIPTION OF THE INVENTION

One aspect of the exemplary embodiments is a method for enhancing the cell phone experience by allowing users to gain the most from offered free minutes by displaying an “in-network” notification when in the same network.

One object of the present invention is providing a cell phone with the ability to display an “in-network” display notification on the display screen or an “in-network” light emitting means. The exemplary embodiments of the present invention detect when a call is initiated and check to determine if both callers are on the same network or not. If both users are determined to be on the same network, an “in-network” display notification is generated on both displays or an “in-network” light emitting means emits light on both cell phones. This permits users to readily determine whether the other caller is on the same network and the callers can use this knowledge to make the most of out of any “in-network” benefits the service provider offers, such as free “in-network” minutes.

The exemplary embodiments of the present invention provide for cell phones equipped with the ability to display an “in-network” display notification on the display screen or an “in-network” light emitting means, depending on the phone manufacturer or model of cell phone. When a user initiates a call, the system checks to determine if both callers are on the same network. For example, a user having a first phone carrier contacts another user having the same phone carrier, and the system ascertains both users are on the same phone carrier network. In this scenario, the “in-network” display notification displays or the “in-network” light emits a light on both cell phones. If a user of a first phone carrier phones a user having a second phone carrier, the second phone carrier being different than the first phone carrier, then the “in-network” display notification is not displayed, nor is the “in-network” light emitted by either cell phone.

In this way, users readily ascertain whether the other caller is on the same network or not and therefore can use this knowledge to make the most of any in-network benefits the provider offers. In addition to this visual indicator, a separate timer may either be implemented for “in-network” versus out-of-network calls, or in another exemplary embodiment, the “in-network” calls may simply be excluded from the minutes aggregated on the “resettable” timer.

The exemplary embodiments of the present invention may use (1) intelligent switches in the network to determine that the call is “in-network” and (2) determine how the intelligent switches ascertain that the call is “in-network” by at least two implementations. These implementations are as follows: (a) by a database look-up to determine if the number is “in-network” or not. This is arguably less reliable as (b) (described below) since phone numbers can be moved across multiple carriers. However, carriers have information about their subscribers, and this information can be used accordingly for this purpose. A better way of accomplishing this is by (b) using the switching information to ascertain if the call is terminated within the same network or if it goes to an outside network. In this case, the data that the call is “in-network” is only determined after the call has been established and cannot have been sent via caller ID. In this implementation, the “in-network” indicator is incorporated into the established call via either a side channel or mixed into a digital signal itself.

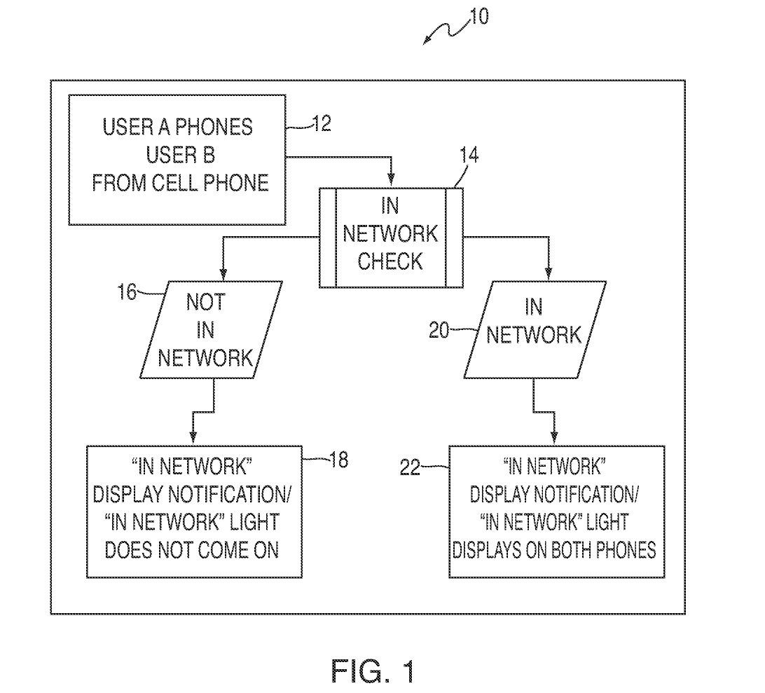

Referring to FIG. 1, one example of a flowchart describing a telephone communication between two users according to the exemplary embodiments of the present invention is illustrated. FIG. 1 illustrates a process 10 for allowing a user A to communicate with a user B and vice versa. In step 12, user A contacts user B via a cell phone. In step 14, a network check is performed in order to determine if user B is in user A's network. If user A is not within user B's network, the process flows to step 16, where it is established that user A is not within user B's network. In step 18, an “in-network” display notification is not displayed on the screen of user B's cell phone, nor on the display screen of user A's cell phone. The notification may be in terms of a light emitted by the cell phone or by displaying text or an image or auditory in nature. If user A is within user B's network, the process flows to step 20, where it is established that user A is within user B's network. In step 22, an “in-network” display notification is displayed on the screen of user B's cell phone, as well as on the display screen of user A's cell phone. The notification may be in terms of a light emitted by the cell phone or by displaying text or an image.

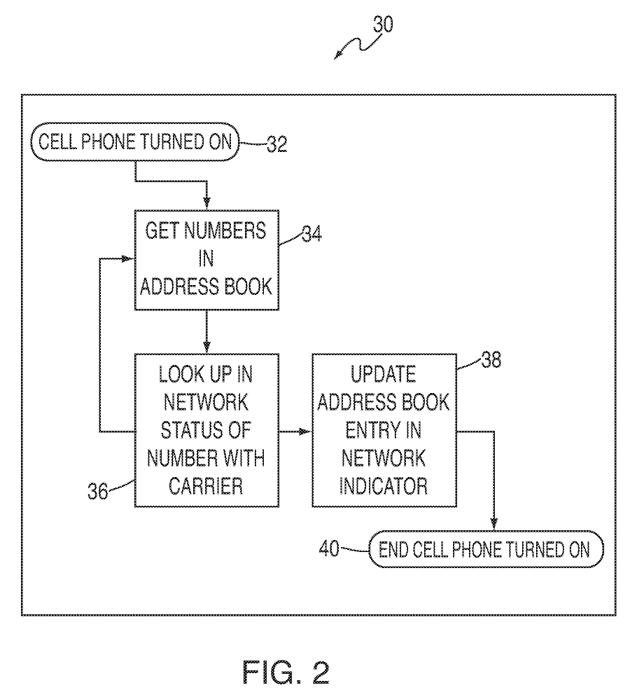

Another exemplary embodiment involves the mobile phone's address book having an indicator flag as to whether the number is “in-network” or not, as described below with reference to FIG. 2. This information is dynamically updated when the phone is turned on. The phone, at start up, then contacts the network to do a database look-up to see if the phone numbers in the address book are in-network. The indicator flag is updated as appropriate for each number. When the user calls that number, it uses the indicator flag to determine if the call is “in-network.” If it is, then the indicator is sent to the recipient's phone as part of the call sequence. In addition, when calling “in-network” a countdown timer can be provided for those without unlimited “in-network” calls.

Referring to FIG. 2, one example of a flowchart describing a method for determining whether a call is “in-network” according to the exemplary embodiments of the present invention is illustrated. FIG. 2 illustrates a process 30 for allowing a user A to automatically perform a database lookup to determine if phone numbers in his/her address book are “in-network”. In step 32, user A's cell phone is turned on. In step 34, user A obtains the phone numbers stored in the address book. In step 36, a look up of the network status of the phone numbers within the same phone carrier as user A is performed. In step 38, user A's address book is updated to indicate whether the phone numbers are in user A's network. If one or more address book phone numbers are in user A's network, then those one or more phone numbers are assigned a visual indication, such as a flag, that indicates to user A that they are in user A's network. In step 40, user A's cell phone is turned off.

Therefore, the exemplary embodiments of the present invention provide for an efficient means of notifying a user that their call is “in-network” and thus potentially subject to certain cost-saving offers offered by certain service providers.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for notifying one or more users of an in-network call, the method comprising:
providing each of the one or more users with one or more transmitting/receiving devices, each of the one or more transmitting/receiving devices having a display screen;
allowing a first user of the one or more users to call a second user of the one or more users;
determining a service provider of the first user;
determining a service provider of the second user;
determining whether the service provider of the first user matches the service provider of the second user; and
automatically notifying the first user and the second user of the in-network call when it is determined that the service provider of the first user matches the service provider of the second user.

2. The method of claim 1, wherein the one or more transmitting/receiving devices are cell phones.

3. The method of claim 1, wherein the automatic notification is displayed on the display screen as text.

4. The method of claim 1, wherein the automatic notification is displayed on the display screen as an image.

5. The method of claim 1, wherein the automatic notification is displayed on the display screen by a light-emitting device.

6. The method of claim 1, wherein a timer is displayed on the display screen of the one or more transmitting/receiving devices of the first user and the second user to monitor duration of the call.

7. The method of claim 6, wherein the timer is a resettable timer for excluding minutes of calls.

8. The method of claim 1, wherein an intelligent switch is used to determine whether the service provider of the first user matches the service provider of the second user.

9. The method of claim 1, wherein one or more phone numbers located in a transmitting/receiving device of a user include a visual indication indicating to the user that the one or more phone numbers are in an in-network status.

10. A system for notifying one or more users of an in-network call, the system comprising:
a network; and
a host system in communication with the network, the host system including software to implement a method comprising:
providing each of the one or more users with one or more transmitting/receiving devices, each of the one or more transmitting/receiving devices having a display screen;
allowing a first user of the one or more users to call a second user of the one or more users;
determining a service provider of the first user;
determining a service provider of the second user;
determining whether the service provider of the first user matches the service provider of the second user; and
automatically notifying the first user and the second user of the in-network call when it is determined that the service provider of the first user matches the service provider of the second user.

11. The system of claim 10, wherein the one or more transmitting/receiving devices are cell phones.

12. The system of claim 10, wherein the automatic notification is displayed on the display screen as text.

13. The system of claim 10, wherein the automatic notification is displayed on the display screen as an image.

14. The system of claim 10, wherein the automatic notification is displayed on the display screen by a light-emitting device.

15. The system of claim 10, wherein a timer is displayed on the display screen of the one or more transmitting/receiving devices of the first user and the second user to monitor duration of the call.

16. The system of claim 15, wherein the timer is a resettable timer for excluding minutes of calls.

17. The system of claim 10, wherein an intelligent switch is used to determine whether the service provider of the first user matches the service provider of the second user.

18. The system of claim 10, wherein one or more phone numbers located in a transmitting/receiving device of a user include a visual indication indicating to the user that the one or more phone numbers are in an in-network status.

19. A computer program product for notifying one or more users of an in-network call, the computer program product comprising:
a storage medium readable by a processing circuit and storing instructions for execution by the processing circuit for performing a method comprising:
providing each of the one or more users with one or more transmitting/receiving devices, each of the one or more transmitting/receiving devices having a display screen;
allowing a first user of the one or more users to call a second user of the one or more users;
determining a service provider of the first user;
determining a service provider of the second user;
determining whether the service provider of the first user matches the service provider of the second user; and
automatically notifying the first user and the second user of the in-network call when it is determined that the service provider of the first user matches the service provider of the second user.
